(19) United States
(12) Patent Application Publication
(10) Pub. No.: US 2015/0108903 A1
(43) Pub. Date: Apr. 23, 2015

(54) LIGHT SENSING KEYBOARD AND A LIGHT EMISSION CONTROL METHOD THEREOF

(71) Applicant: ZIPPY TECHNOLOGY CORP., New Taipei City (TW)

(72) Inventor: Szu-Wei Sun, Taoyuan County (TW)

(73) Assignee: ZIPPY TECHNOLOGY CORP., New Taipei City (TW)

(21) Appl. No.: 14/057,823

(22) Filed: Oct. 18, 2013

(51) Int. Cl. H05B 37/02

(52) U.S. Cl. CPC H05B 37/0218
USPC 315/153

(57) ABSTRACT

A method for controlling light emission of a light sensing keyboard is to save in advance a driving correlation table including a plurality of driving codes in the light sensing keyboard. Each driving code corresponds to a trigger signal and is triggered by the trigger signal to generate a driving signal which defines a light emission mode. When a light detection unit detects ambient light parameters, the trigger signal is generated and the driving code corresponding to the trigger signal is read from the driving correlation table. A control unit generates the driving signal according to the driving code to drive light emission elements to emit light and also control each light emission element to execute the light emission mode corresponding to the driving signal, thereby synchronous or asynchronous colored light alteration can be generated to provide flickering or alternate light alteration effect.

### FIELD OF THE INVENTION

The present invention relates to a keyboard and particularly to a light sensing keyboard and a light emission control method thereof.

### BACKGROUND OF THE INVENTION

Rapid development of personal computers has spurred constant advance of keyboards that serve as basic input devices. To meet different consumers' requirements various light emission keyboards have been introduced into the market to allow users to clearly distinguish key locations and symbols in a dim environment without making erroneous keystrokes and entering wrong commands.

In addition to offering illumination, illuminated keyboards capable of providing colored light alteration also have been developed, such as Taiwan patent No. I384515 (also owned by the Applicant) that discloses a control method to generate varying colored light and an illuminated keyboard thereof. It has a memory unit to save a driving signal table consisting of a plurality of backlight driving signals. Each backlight driving signal corresponds to at least one key-in signal. When the keyboard is depressed to generate the key-in signal, corresponding backlight driving signal is output to drive a light emission element of a backlight unit to emit light in luminosity determined according to driving signal table, so as to provide diversified backlight color variations for the keyboard.

Moreover, Taiwan publication No. 201230107 (also submitted by the Applicant) discloses a control method to generate illumination on an illuminated keyboard. It has different illumination zones on the keyboard and a plurality of different illumination times corresponding to the illumination zones. When a non-depressed key is detected a control unit outputs a driving signal to a corresponding illumination zone to generate illumination asynchronously. Thereby each illumination zone can generate illumination asynchronously to provide a flickering visual effect.

In short, the illuminated keyboards disclosed in the prior art can provide different colored lights. But trigger for illumination alterations has to be set by the keys of the illuminated keyboard. The operation mode lacks versatility. There is still room for improvement.

### SUMMARY OF THE INVENTION

The primary object of the present invention is to provide a technique to change color alteration of lights emitted from a keyboard according to ambient light parameters of ambient lights.

To achieve the foregoing object the invention provides a method for controlling light emission of light sensing keyboards. The method comprises a setting step, a detection step and a driving step. At the setting step, a keyboard is provided which includes a light emission space, a control unit a plurality of light emission elements electrically connected to the control unit and a light detection unit electrically connected to the control unit. The keyboard saves in advance a driving correlation table including a plurality of drive codes. At the detection step, the light detection unit detects ambient light parameters and generates a trigger signal which is corresponding to one driving code and triggers the driving code to generate a driving signal which defines a light emission mode. At the driving step, the driving code corresponding to the trigger signal is read from the driving correlation table and sent to the control unit. The control unit generates a driving signal according to the driving code to drive the light emission elements to generate light towards the light emission space, and controls each light emission element to execute the light emission mode corresponding to the driving signal.

To achieve the foregoing object the invention also provides a light sensing keyboard which comprises a housing including a light emission space, a key assembly disposed in the light emission space, a light detection unit, a circuit board and at least one light emission element. The light detection unit is disposed on the housing to detect ambient light parameters and generate at least one trigger signal. The circuit board is located below the key assembly, and includes a control unit electrically connected to the light detection unit and a memory unit electrically connected to the control unit. The memory unit saves a driving correlation table including of a plurality of driving codes. Each of the plurality of driving codes corresponds to a trigger signal and triggers the control unit to generate a corresponding driving signal. The driving signal defines a light emission mode. The light emission element is located between the key assembly and circuit board and electrically connected to the control unit. The light emission element emits light towards the light emission space according to the driving signal. Each light emission element executes the light emission mode corresponding to drive signal.

In one embodiment the light emission mode is a synchronous light emission mode in which the driving codes are sent to the control unit within a same light emission time to make the light emission elements to emit the light at the same time.

In another embodiment the light emission mode is an asynchronous light emission mode in which the driving codes are sent to the control unit alternately at different light emission times to make the light emission elements to emit the light asynchronously.

In yet another embodiment the light detection unit detects that no change of the ambient light parameters occurs to generate a standby trigger signal, and the corresponding standby driving code is read from the driving correlation table. The control unit generates a standby signal according to the standby driving code to control the light emission elements to execute a standby mode.

In yet another embodiment the light emission elements generate different colored lights that are determined by the different driving signals.

In yet another embodiment the light emission elements generate a single colored light with different luminosities that are determined by the different driving signals.

In yet another embodiment the light detection unit is a charge-coupled device (CCD), a Complementary Metal-Oxide-Semiconductor (CMOS) active pixel sensor, color sensor or ambient light sensor (ALS).

In yet another embodiment the light emission elements generate at least two colored lights selected from a group consisting of red, green, blue or white.

By means of the technique described above, comparing with the conventional techniques the invention can provide many advantages, notably:

1. Through the light sensing keyboard and a light emission control method thereof, the light sensing keyboard can generate light in varying luminosities or colors according to the ambient light parameters.

2. The light sensing keyboard can generate colored light alteration synchronously or asynchronously according to the light emission mode to create a flickering or alternate light alteration effect.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the light sensing keyboard of the invention.

FIG. 2 is an exploded view of the light sensing keyboard of the invention.

FIG. 3 is a structural block diagram of the light sensing keyboard and light emission control method according to the invention.

FIG. 4 is a flowchart of a first embodiment of the light emission control method of the invention.

FIG. 5 is a flowchart of a second embodiment of the light emission control method of the invention

### DETAILED DESCRIPTION OF THE PREFERRED EMBODIMENTS

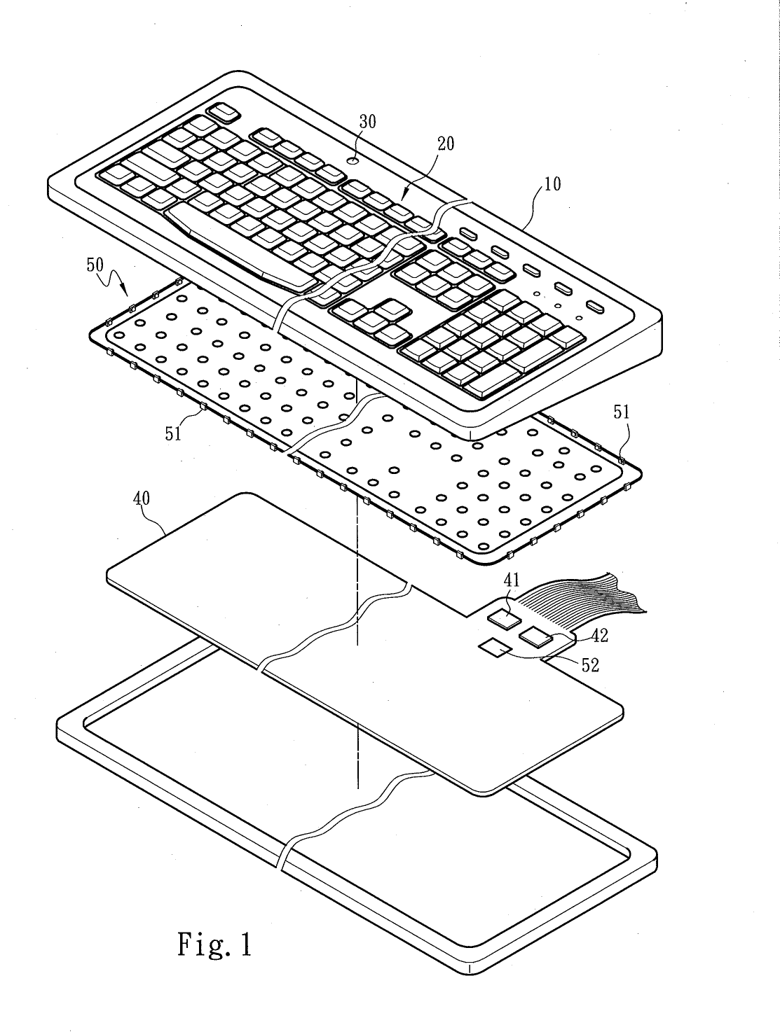

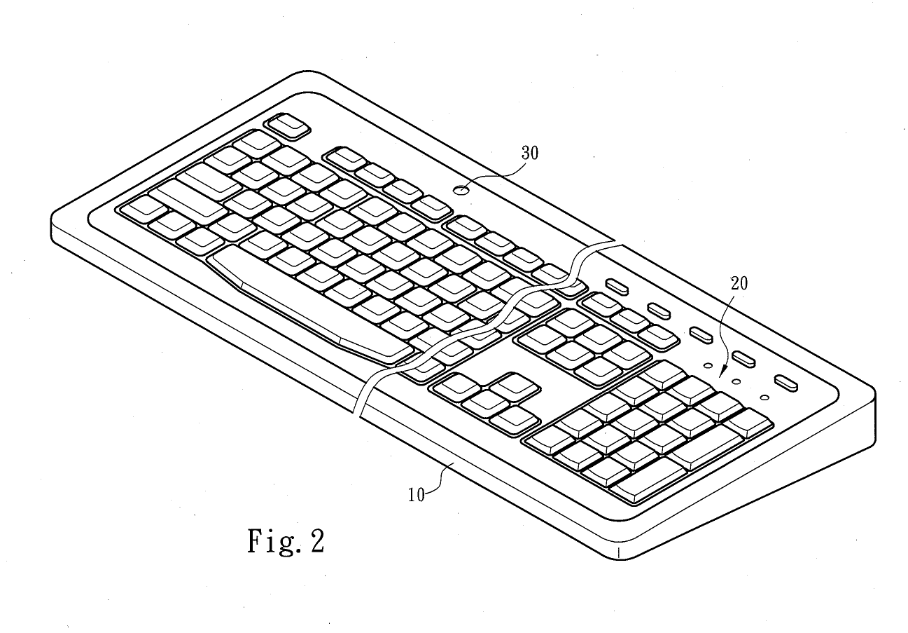

Please referring to FIGS. 1 through 3, the present invention aims to provide a light sensing keyboard that comprises a housing 10, a key assembly 20, a light detection unit 30, a circuit board 40 and a light emission module 50 which includes at least one light emission element 51. The housing 10 has a light emission space. The key assembly 20 is disposed in the light emission space. The light detection unit 30 is disposed on the housing 10 that can be a charge-coupled device (CCD), a CMOS active pixel sensor, a color sensor or an ambient light sensor (ALS) to detect ambient light parameters of the environment to generate at least one trigger signal. The circuit board 40 is located below the key assembly 20 and forms electrical connection with the light detection unit 30, and includes a memory unit 41 and a control unit 42 electrically connected to the memory unit 41. The memory unit 41 saves a driving correlation table including a plurality of driving codes. Each of the plurality of driving codes corresponds to a trigger signal and triggers the control unit 42 to generate a corresponding driving signal which defines a light emission mode. The light emission module 50 is located between the key assembly 20 and circuit board 40. The light emission elements 51 of the light emission module 50 are electrically connected to the control unit 42 and emit light towards the light emission space according to the driving signal. Each light emission element 51 executes the light emission mode corresponding to the driving signal. The light emission element 51 emits at least two colored lights selected from a group consisting of red, green, blue and white, so that colored lights are blended to form colored light alteration.

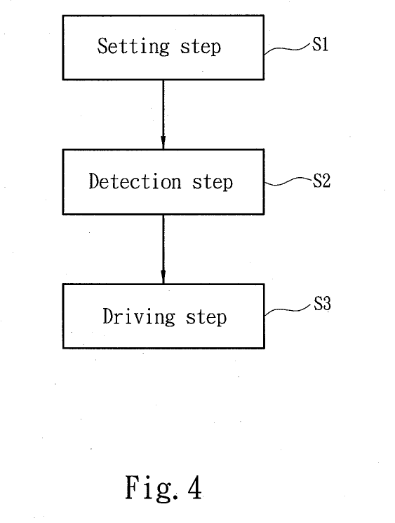

Please refer to FIG. 4 for a flowchart of a first embodiment of the light emission control method of the light sensing keyboard of the invention. The method comprises steps of: S1: setting step, S2: detection step and S3: driving step. At the setting step S1, a keyboard is provided which includes a light emission space, a control unit 42 and a plurality of light emission elements 51 electrically connected to the control unit 42. The light sensing keyboard saves in advance a driving correlation table including a plurality of driving codes. At the detection step S2, a light detection unit 30 detects ambient light parameters (such as color temperature, color frequency and the like) and generates a trigger signal which is corresponding to one driving code and triggers the driving code to generate a driving signal which defines a light emission mode. Finally, at the driving step S3, the driving code corresponding to the trigger signal is read from the driving correlation table and sent to the control unit 42. The control unit 42 generates the driving signal according to the driving code to make the light emission elements 51 emit light towards the light emission space, and controls each light emission element 51 to execute the light emission mode corresponding to the driving signal.

The aforesaid driving correlation table includes a plurality of different driving codes. Each of the plurality of driving codes corresponds to one trigger signal, and is triggered by the trigger signal to generate a driving signal which defines a light emission mode. The driving signal can be a digital signal that includes luminosity information of each light emission unit of the light emission element 51. The driving signal determines the luminosity of light emission element 51. In the event that each light emission element 51 includes three sets of different light emission units (take Red, Greed and Blue as an example), the driving correlation table can look like as follows:

TABLE 1
Example of driving correlation table

| | Color |
|---|---|
| T00 | R₁G₁B₁ |
| T01 | R₂G₂B₂ |
| T02 | R₃G₃B₃ |
| . | . |
| . | . |
| . | . |
| T17 | R_{W}G_{W}B_{W} |

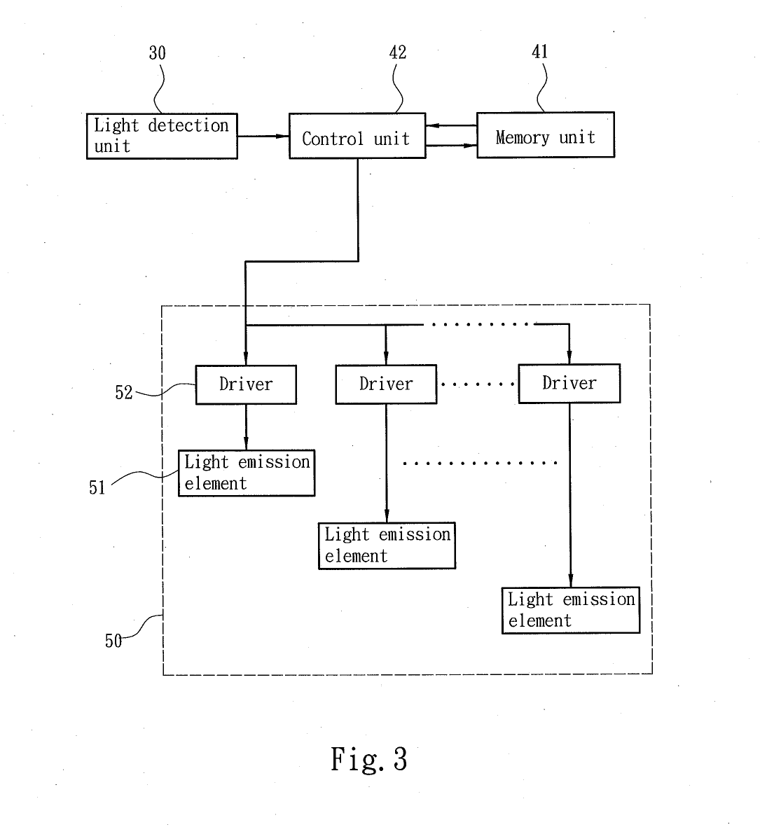

The above table 1 merely serves as an example for discussion. For implementation, the driving correlation table can be adjusted according to a number of the ambient light parameters (such as T00 to T17) corresponding to the trigger signal. R, G and B represent respectively the luminosity information of light emission units of Red, Green and Blue. The luminosity information of different sequence numbers can make the light emission element 51 driven by a corresponding driver 52 to provide different luminosities of the corresponding light emission elements. I.e., driving codes R1G1B1 and R2G2B2 represent different luminosities that generated by driving the corresponding Red, Green and Blue light emission units. For instance, take color temperature for the ambient light parameters as an example, when the light detection unit 30 detects that the color temperature as the ambient light parameter T0 is 2000K, the corresponding driving code T00 for each light emission element 51 is R1G1B1, which is provided to the each driver 52 to drive the corresponding light emission element 51 (referring to FIG. 3) to generate a blended colored light corresponding to the driving code T00, i.e., each light emission element 51 provides a single color.

TABLE 2
Example of driving correlation table

| | L0 | L1 | . . . | L6 | L7 |
|---|---|---|---|---|---|
| T00 | R₁G₁B₁ | R₂G₂B₂ | . . . | R₇G₇B₇ | R₈G₈B₈ |
| T01 | R₉G₉B₉ | R₁₀G₁₀B₁₀ | . . . | R₁₅G₁₅B₁₅ | R₁₆G₁₆B₁₆ |
| T02 | R₁₇G₁₇B₁₇ | R₁₈G₁₈B₁₈ | . . . | R₂₃G₂₃B₂₃ | R₂₄G₂₄B₂₄ |
| . | . | | | | |
| . | . | | | | |
| . | . | | | | |
| T17 | R_{W}G_{W}B_{W} | R_{X}G_{X}B_{X} | . . . | R_{y}G_{y}B_{y} | R_{Z}G_{Z}B_{Z} |

The table 2 above merely serves as an example for discussion. For implementation, the driving correlation table can be adjusted according to a number of the light emission elements 51 (such as L0 to L7) and a number of the ambient light parameters (such as T00 to T17) corresponding to the trigger signals. Take the color temperature as an example for the ambient light parameter, when the light detection unit 30 detects the color temperature as the ambient light parameter T0 is 4000 k, the driving code of the light emission element L0 is R1G1B1, and the driving code of the light emission element L1 is R2G2B2. At table 1 anyone of the driving code mainly is formed by coding of Rn, Gn, Bn (with n representing the corresponding sequence number), and through a signal modulation process of the control unit 42 the driving code is converted to differentiate the individual driving signals of Rn, Gn and Bn which provided to the driver 52 of the light emission element 51. R, G and B represent respectively the luminosity information to drive the red, green and blue light emission units. The luminosity information of different sequence numbers can make each driver 52 to drive the corresponding light emission elements 51 to illuminate in different luminosities. I.e., the driving codes R1G1B1 and R2G2B2 represent driving the red, green and blue light emission units to emit corresponding and varying luminosities. The light provided by each light emission element 51 can be blended to provide a colored light in different colors. Through the control processes previously discussed, the light emission element 51 also can provide a single colored light which can be adjusted in luminosity according to different driving signals. Namely, the driving code generated by each ambient light parameter is different, hence the control unit 42 can control the keyboard to generate diversified variations in luminosity and colors according to the driving codes.

In addition, referring to the examples in Table 2, the driving signal corresponding to the driving code can define at least one light emission mode which can be executed by the light emission element 51 according to the corresponding driving signal. For example, in the event that the detected color temperature as the ambient light parameter T0 is 4000K, the driving code of the light emission element L0 is R1G1B1, and the driving code of the light emission element L1 is R2G2B2, and the driving code of the light emission element L6 is R7G7B7, and the driving code of the light emission element L7 is R9G9B9. The driving codes R1G1B1 and R2G2B2 are set as the first light emission mode, while the driving codes R7G7B7 and R9G9B9 are set as the second light emission mode. The first and second light emission modes are set to send driving codes to the control unit 42 within a same light emission time so that the control unit 42 can control the light emission elements L0 and L1 corresponding to the first light emission mode and the light emission elements L6 and L7 corresponding to the second light emission mode to emit the light synchronously. Or, the first and second light emission modes can be set to send the driving codes R1G1B1-R9G9B9 alternately at different light emission times to the control unit 42 to control the light emission elements L0 and L1 corresponding to the first light emission mode and the light emission elements L6 and L7 corresponding to the second light emission mode to become asynchronous light emission modes that emit light asynchronously, so as to allow the keyboard to emit the light in modes such as flickering or alternate light alteration.

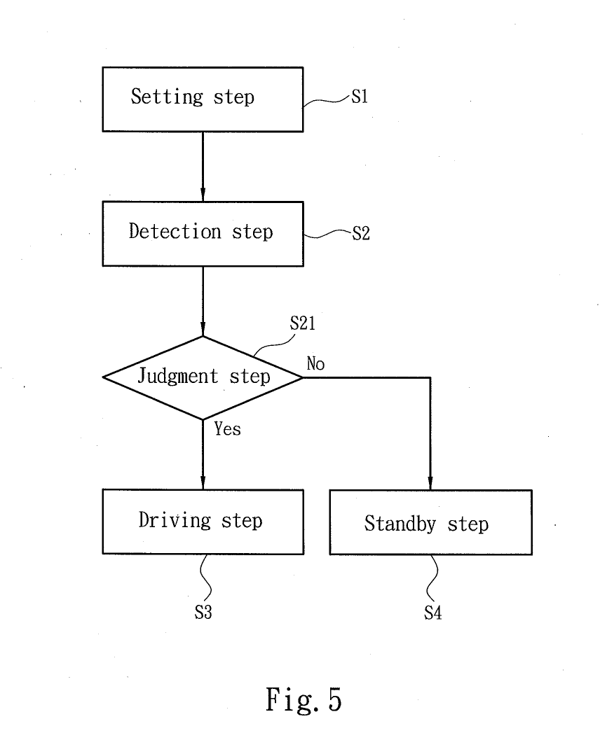

Please refer to FIG. 5 for a flowchart of a second embodiment of the light emission control method of the light sensing keyboard of the invention. In addition to the steps previously discussed for the first embodiment, a judgment step S21 can be added between the detection step S2 and driving step S3. When a new ambient light parameter is detected in the next time, a judgment of whether alteration occurs between the previous ambient light parameter and the new ambient light parameter is executed. If the judgment is positive, the driving step S3 is proceeded according to the new ambient light parameter; otherwise a standby step S4 is proceed. At the standby step S4, a standby driving code is saved in the driving correlation table in advance. When the light detection unit 30 detects that the new ambient light parameter is same as the previous ambient light parameter, a standby trigger signal is generated, and the corresponding standby driving code is read from the driving correlation table. The control unit 42 generates a standby signal according to the standby driving code to control the light emission element 51 to execute a standby mode.

As a conclusion, the light sensing keyboard and the light emission control method thereof provided by the invention mainly saves in advance a driving correlation table including a plurality of driving codes. Each of the plurality of driving codes corresponds to a trigger signal, and is triggered by the trigger signal to generate a driving signal which defines a light emission mode. The light detection unit detects the ambient light parameters to generate the trigger signal, and the driving code corresponding to the trigger signal is read from the driving correlation table to allow the control unit to generate the driving signal to drive each light emission element to emit light towards the light emission space. The control unit can change the luminosity or colors of the light emitted by each light emission element, and also control each light emission element to execute the light emission mode corresponding to the driving signal, thereby produce flickering or alternate light alteration effect through synchronous or asynchronous light emission mode.

What is claimed is:

1. A method for controlling light emission of light sensing keyboards, comprising the steps of:
providing a keyboard including a light emission space, a control unit and a plurality of light emission elements electrically connected to the control unit, and saving a driving correlation table including a plurality of driving codes in the keyboard in advance;
detecting ambient light parameters through a light detection unit to generate a trigger signal, wherein the trigger signal is corresponding to one driving code and triggers the driving code to generate a driving signal which defines a light emission mode; and
reading the driving code corresponding to the trigger signal from the driving correlation table and sending the driving code to the control unit which generates the driving signal according to the driving code to drive the light emission elements to emit light towards the light emission space and controls the light emission elements to execute the light emission mode corresponding to the driving signal.

2. The method of claim 1, wherein the light emission mode is a synchronous light emission mode in which the driving codes are sent to the control unit within a same light emission time to make the light emission elements emit the light synchronously.

3. The method of claim 1, wherein the light emission mode is an asynchronous light emission mode in which the driving codes are sent to the control unit alternately at different light emission times to make the light emission elements emit the light asynchronously.

4. The method of claim 1, wherein the light detection unit detects that no change of the ambient light parameters occurs to generate a standby trigger signal and read a standby driving code which is corresponding to standby trigger signal and stored in the driving correlation table in advance, the control unit generating a standby signal according to the standby driving code to control the light emission elements to execute a standby mode.

5. The method of claim 1, wherein the light emission elements generate different colored lights which are determined by the different driving signals.

6. The method of claim 1, wherein the light emission elements generate a single colored light with different luminosities which are determined by different driving signals.

7. The method of claim 1, wherein the light detection unit is selected from a group consisting of a charge-coupled device, a CMOS (Complementary Metal-Oxide-Semiconductor) active pixel sensor, a color sensor and an ambient light sensor.

8. A light sensing keyboard, comprising:
a housing including a light emission space;
a key assembly disposed in the light emission space;
a light detection unit disposed on the housing to detect ambient light parameters to generate at least one trigger signal;
a circuit board which is located below the key assembly and electrically connected to the light detection unit, and includes a control unit electrically connected to the light detection unit and a memory unit electrically connected to the control unit, the memory unit saving a driving correlation table including a plurality of driving codes, each of the plurality of driving codes corresponding to a trigger signal and being triggered by the trigger signal to generate a driving signal which defines a light emission mode; and
at least one light emission element which is located in the housing and electrically connected to the control unit to emit light towards the light emission space according to the driving signal, and execute the light emission mode corresponding to the drive signal.

9. The light sensing keyboard of claim 8, wherein the light emission mode is a synchronous light emission mode in which the driving codes are sent to the control unit within a same light emission time to make the light emission elements emit the light synchronously.

10. The light sensing keyboard of claim 8, wherein the light emission mode is an asynchronous light emission mode in which the driving codes are sent to the control unit alternately at different light emission times to make the light emission elements emit the light asynchronously.

11. The light sensing keyboard of claim 8, wherein the light emission element generates different colored lights which are determined by the different driving signals.

12. The light sensing keyboard of claim 8, wherein the light emission element generates a single colored light with different luminosities which are determined by different driving signals.

13. The light sensing keyboard of claim 8, wherein the light detection unit is selected from a group consisting of a charge-coupled device, a CMOS (Complementary Metal-Oxide-Semiconductor) active pixel sensor, a color sensor and an ambient light sensor.

14. The light sensing keyboard of claim 8, wherein the light emission element generates at least two colored lights selected from a group consisting of red, green, blue and white.
